(19) United States
(12) Patent Application Publication
(10) Pub. No.: US 2012/0176542 A1
(43) Pub. Date: Jul. 12, 2012

(54) INPUT SELECTION DEVICE, VIDEO/SOUND REPRODUCTION SYSTEM, AND VIDEO/SOUND REPRODUCTION METHOD

(75) Inventor: Yasunori Yoshino, Matsumoto-shi (JP)

(73) Assignee: Seiko Epson Corporation, Tokyo (JP)

(21) Appl. No.: 13/340,941

(22) Filed: Dec. 30, 2011

(30) Foreign Application Priority Data
Jan. 7, 2011 (JP) 2011-001732

(51) Int. Cl. H04N 3/27

(52) U.S. Cl. 348/554; 348/E03.049

(57) ABSTRACT

When an HDMI key of an input operation unit is operated, a control unit outputs, to a projector, a control signal indicating that an HDMI terminal is selected from a control signal output unit, such that video based on a video signal separated from an input signal to the HDMI terminal is projected, and a sound signal separated from the input signal to the HDMI terminal is output from a mini jack to a mini jack of a switcher. The control unit issues an instruction to a sound signal selection unit to select a sound signal which is input to the mini jack serving as a sound input terminal corresponding to the HDMI terminal. As a result, sound based on the sound signal included in the input signal to the HDMI terminal is output from a speaker.

The entire disclosure of Japanese Patent Application No. 2011-1732, filed January 7 is expressly incorporated by reference herein.

### BACKGROUND

1. Technical Field

The present invention relates to an input selection device which selects an input source to be displayed from a plurality of input sources, a video/sound (video/audio) reproduction system including the input selection device, and a video/sound reproduction method in the video/sound reproduction system.

2. Related Art

A video display device, such as a projector, includes a number of video input terminals or sound input terminals, such that various external video/sound supply devices (input sources) are connectable thereto. A user operates an operation panel in the main body of the device or a remote controller to select a display-target input source from among a plurality of input sources (for example, see JP-A-2003-274316).

When this video display device is used in a place, such as a classroom of a school, there is a case where the video display device is attached at a high position, and sound is output from a comparatively large external speaker. On the other hand, if the video display device is at a high position, it is difficult to connect an input source again in each case, or to select an input source to be displayed. For this reason, an input selection device to which a plurality of input sources are connectable and which can select an input source to be displayed on a video display device is disposed at a position where an input source is easily connected, and video signals and sound signals are respectively supplied to the video display device and an external speaker through the input selection device.

However, if a video input terminal (for example, an HDMI terminal) to which both video signals and sound signals are input are provided in the input selection device configured as above, there is a need for separating the video signals which are supplied to the video display device and the sound signals which are supplied to the external speaker in the input selection device. For this reason, the configuration of the input selection device is complicated, causing an increase in cost.

### SUMMARY

An advantage of some aspects of the invention is to solve at least a part of the problems described above, and the invention can be implemented as the following forms or application examples.

### Application Example 1

This application example of the invention is directed to an input selection device including: a plurality of video input terminals to which video signals are input, a plurality of sound input terminals which are associated with the plurality of video input terminals, and to which sound signals corresponding to the video signals are input, an input operation unit which receives a selection operation for selecting one of the plurality of video input terminals, and a control unit which performs control such that video based on a video signal input to a video input terminal selected by the selection operation is displayed on a video display device, and sound based on a sound signal input to a sound input terminal corresponding to the selected video input terminal is output from a sound output device. The plurality of video input terminals include a first video input terminal to which both a video signal and a sound signal are input, and the plurality of sound input terminals include a first sound input terminal which is associated with the first video input terminal.

With this input selection device, the control unit performs control such that video based on a video signal to be input to the video input terminal selected by the selection operation is displayed on the video display device, and sound based on a sound signal to be input to the sound input terminal corresponding to the selected video input terminal is output from the sound output device. For this reason, when the first video input terminal to which both a video signal and a sound signal are input is selected by the selection operation, the control unit performs control such that video based on the video signal to be input to the first video input terminal is displayed on the video display device, and sound based on the sound signal to be input to the first sound input terminal corresponding to the first video input terminal is output from the sound output device. If the video signal and the sound signal which are input to the first video input terminal are output to the video display device as they are, such that video based on the video signal is displayed on the video display device, and the sound signal is separated in the video display device and input to the first sound input terminal, sound based on the sound signal can be output from the sound output device. That is, since there is no need for separating the video signal and the sound signal, which are input to the first video input terminal, in the input selection device when video display and sound output are performed in different devices, it becomes possible to simplify the configuration and to suppress an increase in cost.

### Application Example 2

It is preferred that the input selection device further includes a plurality of video output terminals which output the video signals input to the plurality of video input terminals to the video display device, and a control signal output unit which outputs a control signal to the video display device. The control unit outputs a control signal according to the selection result of the selection operation from the control signal output unit to perform control such that video based on a video signal input to a video input terminal selected by the selection operation from among the video signals output from the plurality of video output terminals is displayed on the video display device.

### Application Example 3

It is preferred that the input selection device further includes a sound output terminal which outputs the sound signal to the sound output device, and a sound signal selection unit which determines a sound signal to be output from the sound output terminal from among the sound signals input to the plurality of sound input terminals in accordance with the selection result of the selection operation.

### Application Example 4

In the input selection device, the first video input terminal may be an HDMI terminal.

### Application Example 5

In the input selection device, the first video input terminal may be a USB terminal.

### Application Example 6

This application example of the invention is directed to a video/sound reproduction system including: an input selection device to which video signals and sound signals are input, a video display device which displays video based on a video signal input to the input selection device, and a sound output device which outputs sound based on a sound signal input to the input selection device. The input selection device includes a plurality of video input terminals to which video signals are input, a plurality of sound input terminals which are associated with the plurality of video input terminals, and to which the sound signals corresponding to the video signals are input, an input operation unit which receives a selection operation for selecting one of the plurality of video input terminals, and a control unit which performs control such that video based on a video signal input to the video input terminal selected by the selection operation is displayed on the video display device, and sound based on a sound signal input to a sound input terminal corresponding to the video input terminal selected by the selection operation is output from the sound output device. The plurality of video input terminals include a first video input terminal to which both the video signal and the sound signal are input, and the plurality of sound input terminals include a first sound input terminal which is associated with the first video input terminal. The video display device includes a second video input terminal to which the video signal and the sound signal input to the first video input terminal of the input selection device are input from the input selection device, a separation unit which separates the video signal and the sound signal input to the second video input terminal from each other, a display unit which, when the first video input terminal is selected by the selection operation, displays video based on the video signal separated by the separation unit, and a sound output terminal which, when the first video input terminal is selected by the selection operation, outputs the sound signal separated by the separation unit to the first sound input terminal of the input selection device.

With this video/sound reproduction system, the control unit of the input selection device performs control such that video based on a video signal to be input to the video input terminal selected by the selection operation is displayed on the video display device, and sound based on a sound signal to be input to the sound input terminal corresponding to the selected video input terminal is output from the sound output device. For this reason, when the first video input terminal to which both a video signal and a sound signal are input is selected by the selection operation, the control unit of the input selection device performs control such that video based on the video signal to be input to the first video input terminal is displayed on the video display device, and sound based on the sound signal to be input to the first sound input terminal corresponding to the first video input terminal is output from the sound output device. The video signal and the sound signal which are input to the first video input terminal are input to the second video input terminal of the video display device, and are separated into the video signal and the sound signal by the separation unit of the video display device. The video display device displays video based on the separated video signal by the display unit, and outputs the separated sound signal from the sound output terminal to the first sound input terminal of the input selection device. As a result, sound based on the sound signal is output from the sound output device. That is, since there is no need for separating the video signal and the sound signal, which are input to the first video input terminal, in the input selection device when video display and sound output are performed in different devices, it becomes possible to simplify the configuration of the input selection device and to suppress an increase in cost.

### Application Example 7

It is preferred that, in the video/sound reproduction system, the input selection device further includes a plurality of video output terminals which output the video signals input to the plurality of video input terminals to the video display device, and a control signal output unit which outputs a control signal to the video display device. The control unit outputs a control signal according to the selection result of the selection operation from the control signal output unit to perform control such that video based on a video signal input to a video input terminal selected by the selection operation from among the video signals output from the plurality of video output terminals is displayed on the video display device.

### Application Example 8

It is preferred that, in the video/sound reproduction system, the input selection device further includes a sound output terminal which outputs the sound signal to the sound output device, and a sound signal selection unit which determines a sound signal to be output from the sound output terminal from among the sound signals input to the plurality of sound input terminals on the basis of the selection operation.

### Application Example 9

In the video/sound reproduction system, the first video input terminal may be an HDMI terminal.

### Application Example 10

In the video/sound reproduction system, the first video input terminal may be a USB terminal.

### Application Example 11

This application example of the invention is directed to a video/sound reproduction method in a video/sound reproduction system. The video/sound reproduction system includes an input selection device to which video signals and sound signals are input, a video display device which displays video based on a video signal input to the input selection device, and a sound output device which outputs sound based on a sound signal input to the input selection device. The video/sound reproduction method includes causing an input selection device to receive a selection operation for selecting a first video input terminal, to which both the video signal and the sound signal are input, from among a plurality of video input terminals, causing the input selection device to output the video signal and the sound signal input to the first video input terminal to the video display device, causing the video display device to separate the video signal and the sound signal from each other, causing the video display device to display video based on the separated video signal, causing the video display device to output the separated sound signal to the input selection device, causing the input selection device to output the sound signal input from the video display device to the sound output device, and causing the sound output device to output sound based on the sound signal input from the input selection device.

### BRIEF DESCRIPTION OF THE DRAWINGS

The invention will be described with reference to the accompanying drawings, wherein like numbers reference like elements.

FIG. 1 is a perspective view showing the schematic configuration of a video/sound reproduction system.

FIG. 2 is a block diagram showing the schematic configuration of a projector.

FIG. 3 is a perspective view showing a switcher.

FIG. 4 is a front view showing an input operation unit of a switcher.

FIG. 5 is a block diagram showing the schematic configuration of a switcher.

### DESCRIPTION OF EXEMPLARY EMBODIMENTS

Hereinafter, a video/sound reproduction system of this embodiment will be described with reference to the drawings.

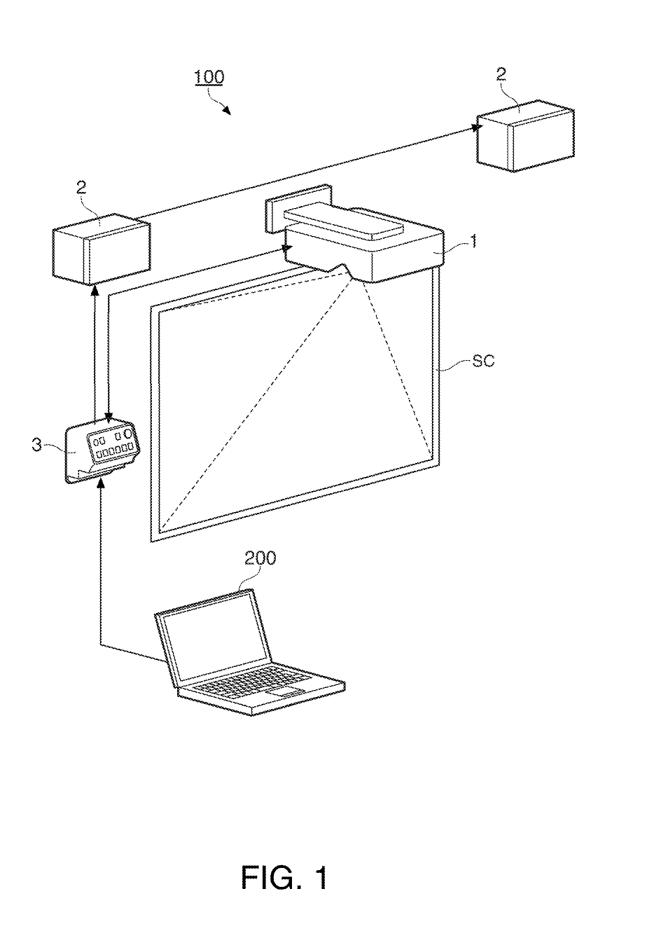

FIG. 1 is a perspective view showing the schematic configuration of the video/sound reproduction system of this embodiment.

As shown in FIG. 1, a video/sound reproduction system 100 includes a projector 1 serving as a video display device, a speaker 2 serving as a sound output device, and a switcher serving as an input selection device. An external video/sound supply device 200 (for example, a computer) is appropriately connected to the switcher 3, and video signals and sound signals are supplied from the video/sound supply device 200 to the switcher 3. The switcher 3 outputs the supplied video signals to the projector 1, and also outputs the supplied sound signals to the speaker 2. The projector 1 of this embodiment is a close projection-type projector using a short focus lens, and is fixed at the upper part of the wall surface. The projector 1 projects (displays) video based on a video signal to be input from the switcher 3 toward a screen SC disposed on the lower side along the wall surface thereof. The speaker 2 is, for example, an active-type speaker equipped with an amplifier, and outputs sound based on a sound signal input from the switcher 3. The switcher 3 is disposed at a lower position than the projector 1 such that the video/sound supply device 200 is easily connected or disconnected. The projector 1 may be a general-purpose projector which is usable as a stand-alone type or may be a projector exclusively for the video/sound reproduction system 100.

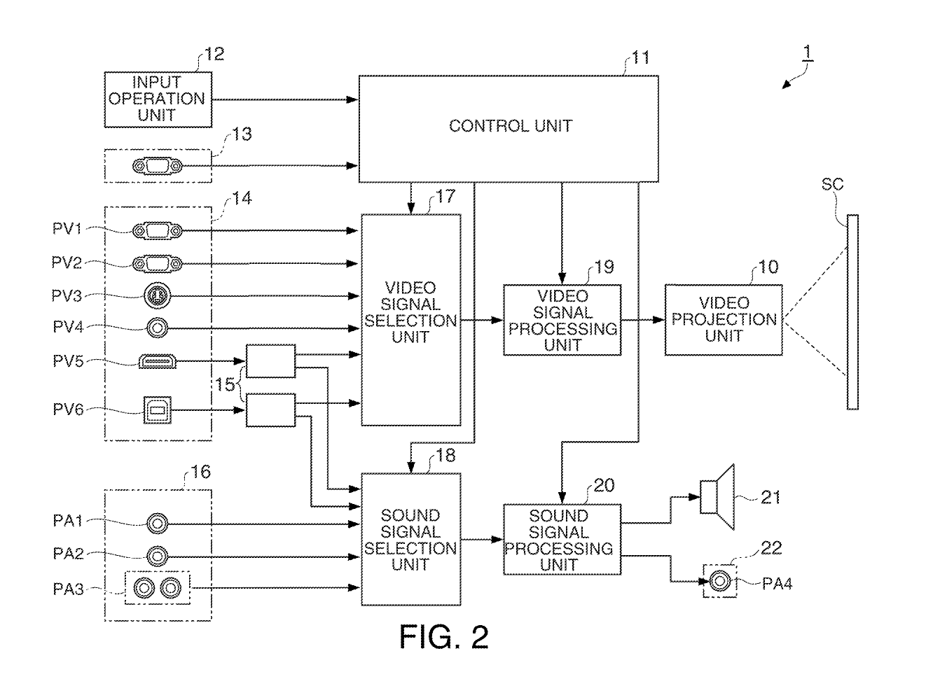

FIG. 2 is a block diagram showing the schematic configuration of the projector 1.

As shown in FIG. 2, the projector 1 includes a video projection unit 10, a control unit 11, an input operation unit 12, a control signal input unit 13, a video signal input unit 14, a video/sound separation unit 15, a sound signal input unit 16, a video signal selection unit 17, a sound signal selection unit 18, a video signal processing unit 19, a sound signal processing unit 20, a speaker 21, and a sound signal output unit 22.

The video projection unit 10 includes alight source device, a light modulation device such as a liquid crystal light valve, a projection lens, and the like (all of which are not shown). The video projection unit 10 corresponds to a display unit. The video projection unit 10 modulates light emitted from the light source device by the light modulation device to form an image (video), and projects the image from the projection lens on a magnified scale to display the image on the projection surface, such as the screen SC.

The control unit 11 includes a CPU (Central Processing Unit), a RAM (Random Access Memory) which is used to temporarily store various kinds of data, a nonvolatile ROM (Read Only Memory), and the like. The CPU operates in accordance with a control program stored in the ROM to perform overall control of the operation of the projector 1.

The input operation unit 12 receives an input operation of the user, and includes a plurality of operation keys which are used when the user issues various instructions to the projector 1. The operation keys provided in the input operation unit 12 of this embodiment include a power key which is used to turn on and off the power supply, an input source selection key which is used to select an input source, and the like. If the user operates various operation keys of the input operation unit 12, the input operation unit 12 receives the input operations and outputs operation signals according to the operation contents of the user to the control unit 11.

The control signal input unit 13 includes an RS-232C terminal, is connected to an external control device, such as a computer, and receives a control signal from the control device as input. The control signal input unit 13 outputs the input control signal to the control unit 11, and the control unit 11 can control the operation of the projector 1 on the basis of the control signal. The switcher 3 is connected to the control signal input unit 13 of this embodiment, and the control signal is input from the switcher 3 to the control signal input unit 13.

The video signal input unit 14 includes a plurality of video input terminals. In this embodiment, there are two VGA terminals PV1 and PV2 to which an analog RGB signal is input from a computer or the like, an S terminal PV3 to which an S video signal is input from a video apparatus or the like, a composite terminal PV4 to which a composite signal is input from a video apparatus or the like, an HDMI terminal PV5 to which a digital video signal or the like based on the HDMI (High Definition Multimedia Interface) standard is input from a video apparatus, a computer, or the like, and a USB terminal (USB Type B terminal) PV6 to which a digital video signal or the like based on the USB (Universal Serial Bus) standard is input from a computer or the like in which specific software is installed.

An input signal which is input to the HDMI terminal PV5 and the USB terminal PV6 from among the video input terminals may include both a video signal and a sound signal. For this reason, the input signal which is input to the HDMI terminal PV5 and the USB terminal PV6 is separated into a video signal and a sound signal by the video/sound separation unit 15.

The sound signal input unit 16 includes a plurality of sound input terminals. In this embodiment, a plurality of sound input terminals include two mini jacks PA1 and PA2 to which an analog sound signal is input from a computer or the like, and a set of pin jacks PA3 to which an analog sound signal is input from a video apparatus or the like. The sound input terminals are associated with the video input terminals. Specifically, the mini jack PA1 is associated with the VGA terminal PV1, and a sound signal corresponding to a video signal input to the VGA terminal PV1 is input to the mini jack PA1. The mini jack PA2 is associated with the VGA terminal PV2, and a sound signal corresponding to a video signal input to the VGA terminal PV2 is input to the mini jack PA2. The pin jack PA3 is associated with both the S terminal PV3 and the composite terminal PV4, and a sound signal corresponding to a video signal input to the S terminal PV3 or the composite terminal PV4 is input to the pin jack PA3.

A video signal input to the video signal input unit 14 and a video signal separated by the video/sound separation unit 15 are input to the video signal selection unit 17. The video signal selection unit 17 selects one video signal under the control of the control unit 11, and outputs the video signal to the video signal processing unit 19. The user operates an input source selection key provided in the input operation unit 12 (selection operation) to select one video input terminal. The control unit 11 instructs the video signal selection unit 17 so as to select a video signal input to the video input terminal selected by the user.

A sound signal input to the sound signal input unit 16 and a sound signal separated by the video/sound separation unit 15 are input to the sound signal selection unit 18. The sound signal selection unit 18 selects any one sound signal under the control of the control unit 11, and outputs the sound signal to the sound signal processing unit 20. The control unit 11 causes the sound signal selection unit 18 to select a sound signal input to the sound input terminal corresponding to the video input terminal selected by the user. That is, when the VGA terminal PV1 is selected by the input source selection key, a sound signal input to the mini jack PA1 is selected, when the VGA terminal PV2 is selected, a sound signal input to the mini jack PA2 is selected, and when any one of the S terminal PV3 and the composite terminal PV4 is selected, the pin jack PA3 is selected. When the HDMI terminal PV5 or the USB terminal PV6 is selected, a sound signal separated from each input signal is selected.

The video signal processing unit 19 converts a video signal input from the video signal selection unit 17 to a video signal having a format suitable for forming an image in the light modulation device of the video projection unit 10. The video signal processing unit 19 performs an image quality adjustment process for adjusting brightness, contrast, or the like on the converted video signal on the basis of an instruction of the control unit 11 as necessary, and outputs the video signal subjected to the process to the video projection unit 10. As a result, video based on the video signal input to the video signal input unit 14 is projected from the video projection unit 10.

The sound signal processing unit 20 appropriately performs a process, such as a volume adjustment process or a sound quality adjustment process, on a sound signal input from the sound signal selection unit 18 on the basis of an instruction of the control unit 11. The sound signal subjected to the process is output to the speaker 21, and sound based on the sound signal is output from the speaker 21. The sound signal output unit 22 which includes a mini jack PA4 serving as a sound output terminal is connected to the sound signal processing unit 20, and can output the sound signal subjected to the process outside the projector 1. The sound signal output unit 22 includes a detection unit (not shown) which detects whether or not a connection terminal (mini plug) of a sound cable is connected to the mini jack PA4, and the sound signal processing unit 20 switches the output destination of a sound signal in accordance with the detection result. That is, when the mini plug is not connected to the mini jack PA4, the sound signal processing unit 20 outputs a sound signal to the speaker 21 and causes the speaker 21 to output sound. When the mini plug is connected to the mini jack PA4, sound is not output from the speaker 21, and a sound signal is output to the outside through the sound signal output unit 22.

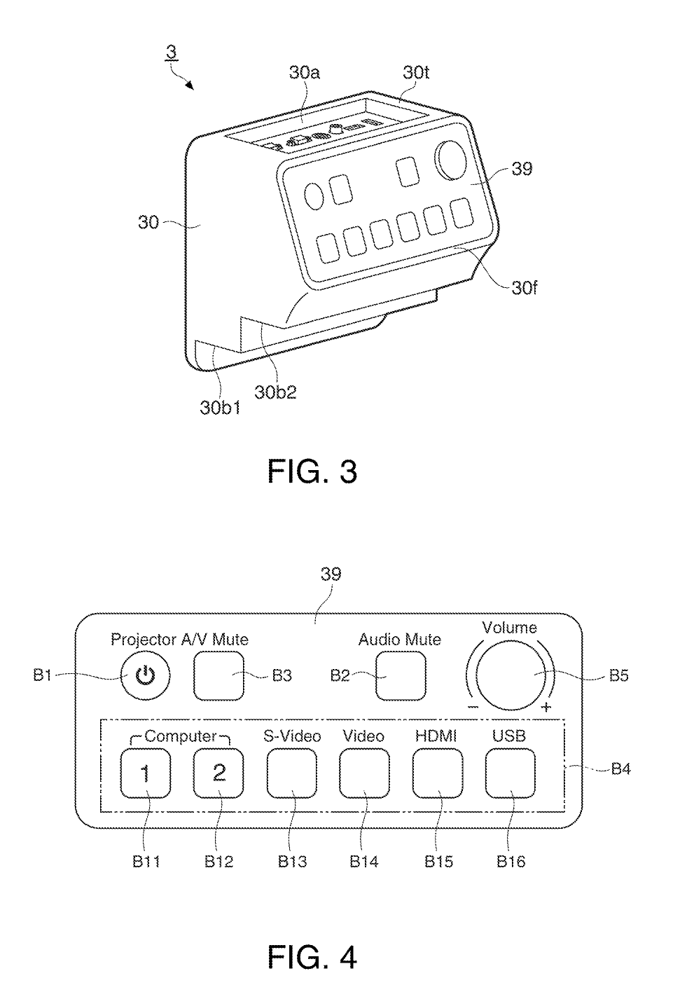

FIG. 3 is a perspective view showing the switcher 3.

As shown in FIG. 3, the switcher 3 is covered by the boxlike casing 30, and an input operation unit 39 which is used when the user performs an input operation is disposed in a front surface 30f of the casing 30. The operation surface of the input operation unit 39 is inclined slightly upward, such that the user can easily perform an input operation. A concave portion 30a is formed in an upper surface 30t of the casing 30, and a plurality of terminals which are used for connection to the projector 1 or the speaker 2 are arranged in the concave portion 30a (the details will be described below). A step is provided in the bottom surface of the casing 30, and two surfaces (first bottom surface 30b1 and second bottom surface 30b2) which are different in height are formed. A plurality of terminals which are used for connection to the video/sound supply device 200 are arranged in the first and second bottom surfaces 30b1 and 30b2 (the details will be described below).

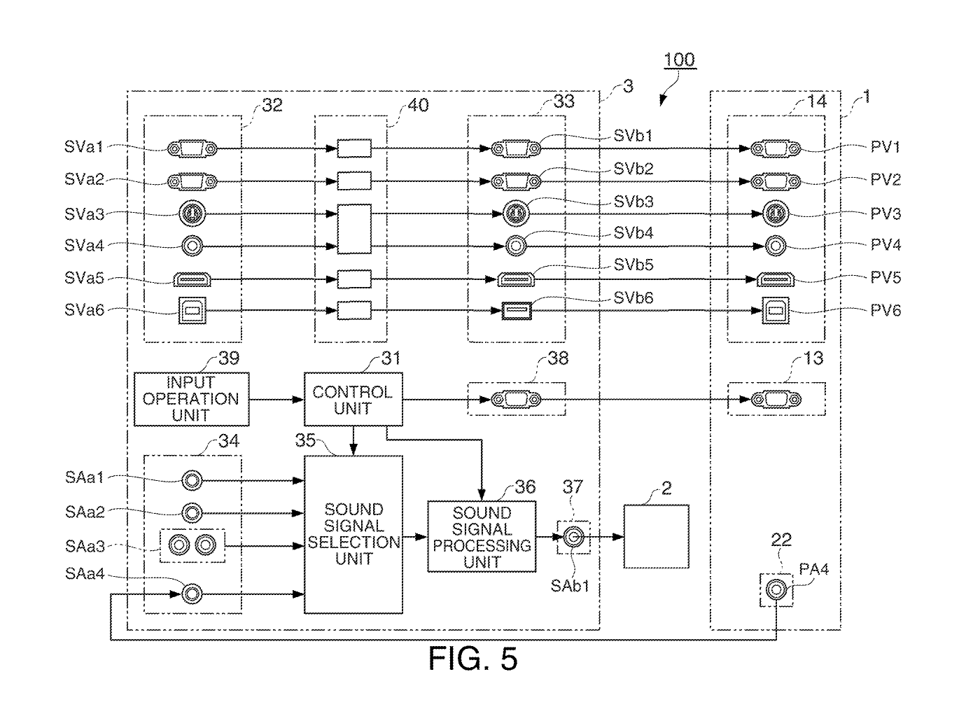

FIG. 4 is a front view showing the input operation unit 39 of the switcher 3. FIG. 5 is a block diagram showing the schematic configuration of the switcher 3.

As shown in FIG. 5, the switcher 3 includes a control unit 31, a video signal input unit 32, a video signal output unit 33, a sound signal input unit 34, a sound signal selection unit 35, a sound signal processing unit 36, a sound signal output unit 37, a control signal output unit 38, and an input operation unit 39.

The control unit 31 includes a CPU, a RAM, a ROM, and the like, and the CPU operates in accordance with a control program stored in the ROM to perform overall control of the operation of the switcher 3.

The video signal input unit 32 includes a plurality of video input terminals corresponding to the video input terminals of the video signal input unit 14 of the projector 1. Video signals are input from the video/sound supply device 200 (see FIG. 1) to the video signal input unit 32. That is, the video signal input unit 32 includes two VGA terminals SVa1 and SVa2, an S terminal SVa3, a composite terminal SVa4, an HDMI terminal SVa5, and a USB terminal (USB Type B terminal) SVa6. The video input terminals of the video signal input unit 32 are arranged in the first bottom surface 30b1 (see FIG. 3) of the casing 30.

The video signal output unit 33 includes a plurality of video output terminals corresponding to the video input terminals of the video signal input unit 32, that is, a plurality of video output terminals corresponding to the video input terminals of the video signal input unit 14 of the projector 1, and outputs the video signals input to the video signal input unit 32 to the projector 1. That is, the video signal output unit 33 includes two VGA terminals SVb1 and SVb2, an S terminal SVb3, a composite terminal SVb4, an HDMI terminal SVb5, and a USB terminal (USB Type A terminal) SVb6. The video input terminals of the video signal input unit 32 and the video output terminals of the video signal output unit 33 are correspondingly connected to each other through various circuits 40, such as a buffer and an amplifier. The video output terminals of the video signal output unit 33 are arranged in the upper surface 30t (see FIG. 3) of the casing 30, and are constantly correspondingly connected to the video input terminals of the video signal input unit 14 of the projector 1 through cables (not shown). For this reason, the video signals input to the video signal input unit 32 of the switcher 3 are input to the video signal input unit 14 of the projector 1 in an unchanged format.

The sound signal input unit 34 includes a plurality of sound input terminals corresponding to the sound input terminals of the sound signal input unit 16 of the projector 1, and receives the sound signals from the video/sound supply device 200 (see FIG. 1) as input. That is, the sound signal input unit 34 includes two mini jacks SAa1 and SAa2, and a set of pin jacks SAa3, and these sound input terminals are arranged in the second bottom surface 30b2 of the casing 30. The sound signal input unit 34 includes one mini jack SAa4, in addition to the sound input terminals. The mini jack SAa4 is disposed in the upper surface 30t (see FIG. 3) of the casing 30, and is constantly connected to the mini jack PA4 of the sound signal output unit 22 of the projector 1 through a cable (not shown). Similarly to the projector 1, the sound input terminals are associated with the video input terminals. Specifically, the mini jack SAa1 is associated with the VGA terminal SVa1, and a sound signal corresponding to a video signal input to the VGA terminal SVa1 is input to the mini jack SAa1. The mini jack SAa2 is associated with the VGA terminal SVa2, and a sound signal corresponding to a video signal input to the VGA terminal SVa2 is input to the mini jack SAa2. The pin jack SAa3 is associated with both the S terminal SVa3 and the composite terminal SVa4, and a sound signal corresponding to a video signal input to the S terminal SVa3 or the composite terminal SVa4 is input to the pin jack SAa3. The mini jack SAa4 is associated with both the HDMI terminal SVa5 and the USB terminal SVa6 with no corresponding sound input terminal.

The sound signals input to the sound signal input unit 34 are input to the sound signal selection unit 35. The sound signal selection unit 35 selects any one sound signal under the control of the control unit 31, and outputs the sound signal to the sound signal processing unit 36.

The sound signal processing unit 36 appropriately performs a process, such as a volume adjustment process, on the sound signal input from the sound signal selection unit 35, and outputs the sound signal subjected to the process to the sound signal output unit 37.

The sound signal output unit 37 includes a mini jack SAb1, and outputs the sound signal processed by the sound signal processing unit 36 from the mini jack SAb1 to the outside the switcher 3. The mini jack SAb1 of the sound signal output unit 37 is disposed in the upper surface 30t (see FIG. 3) of the casing 30, and is constantly connected to the speaker 2 through a cable (not shown). That is, the sound signal processed by the sound signal processing unit 36 is output to the speaker 2, and sound based on the sound signal is output from the speaker 2.

The control signal output unit 38 includes an RS-232C terminal. The RS-232C terminal is disposed in the upper surface 30t of the casing 30, and is constantly connected to the control signal input unit 13 of the projector 1 through a cable (not shown). The control unit 31 of the switcher 3 outputs a control signal to the projector 1 through the control signal output unit 38, and can control the operation of the projector 1.

The input operation unit 39 receives an input operation of the user, and includes a plurality of operation keys or operation knobs which are used when the user issues various instructions to the switcher 3. As shown in FIG. 4, the operation keys or operation knobs provided in the input operation unit 39 of this embodiment include a power key B1 which is used to turn on and off the power supply of the projector 1, a sound mute key B2 which is used to stop the output of sound, a video/sound mute key B3 which is used to stop the output of sound and the display of video, a plurality of input source selection keys B4 which are used to select an input source, and a volume knob B5 which is used to adjust the volume level of sound. If the user performs various operations on the input operation unit 39, the input operation unit 39 receives the input operations, and outputs operation signals according to the operation contents of the user to the control unit 31. The input source selection keys B4 include a plurality of operation keys corresponding to the video input terminals provided in the video signal input unit 32, and each operation key is operated to select any one video input terminal. That is, the input source selection key B4 includes a Computer 1 key B11 which is used to select the VGA terminal SVa1, a Computer 2 key B12 which is used to select the VGA terminal SVa2, an S-Video key B13 which is used to select the S terminal SVa3, a Video key B14 which is used to select the composite terminal SVa4, an HDMI key B15 which is used to select the HDMI terminal SVa5, and a USB key B16 which is used to select the USB terminal SVa6.

Next, the operations of the switcher 3 and the projector 1 when each operation key or operation knob of the input operation unit 39 is operated will be described.

When the user operates the power key B1 of the input operation unit 39, the control unit 31 outputs a control signal (power supply control signal) for turning on and off the power supply of the projector 1 from the control signal output unit 38 to the projector 1. If the power supply control signal is input through the control signal input unit 13, similarly to a case where the power key of the input operation unit 12 of the projector 1 is operated, the control unit 11 of the projector 1 turns on and off the power supply.

When the user operates the sound mute key B2 of the input operation unit 39, the control unit 31 instructs the sound signal processing unit 36 to stop the output of sound.

When the user operates the video/sound mute key B3 of the input operation unit 39, the control unit 31 causes the sound signal processing unit 36 to stop the output of sound, and also outputs an operation signal (video mute signal) for stopping the display of video from the control signal output unit 38 to the projector 1. If the video mute signal is input through the control signal input unit 13, the control unit 11 of the projector 1 instructs the video signal processing unit 19 to switch the display state from a state (normal state) where an input image from the video/sound supply device 200 is displayed to a state (video mute state) where a solid image of a predetermined color (for example, black) is displayed. When the video mute signal is input in the video mute state, the control unit 11 of the projector 1 returns the display state from the video mute state to the normal state.

When the user operates the volume knob B5 of the input operation unit 39, the control unit 31 instructs the sound signal processing unit 36 to adjust the volume level of sound.

When the user operates each input source selection key B4 of the input operation unit 39, the switcher 3 and the projector 1 operate as follows in accordance with the operated operation key.

When the Computer 1 key B11 is operated and the VGA terminal SVa1 is selected, the control unit 31 outputs a control signal indicating the selection of the VGA terminal SVa1 from the control signal output unit 38 to the projector 1. If the control signal is input through the control signal input unit 13, the control unit 11 of the projector 1 instructs the video signal selection unit 17 to select a video signal input to the VGA terminal PV1 corresponding to the selected VGA terminal SVa1. The control unit 31 of the switcher 3 instructs the sound signal selection unit 35 to select a sound signal input to the mini jack SAa1 serving as a sound input terminal corresponding to the selected VGA terminal SVa1. As a result, video based on the video signal input to the VGA terminal PV1 of the projector 1, that is, the video signal input to the VGA terminal SVa1 of the switcher 3 is projected from the video projection unit 10 of the projector 1, and sound based on the sound signal input to the mini jack SAa1 is output from the speaker 2.

When the Computer 2 key B12, the S-Video key B13, and the Video key B14 are operated, the switcher 3 and the projector 1 operate in the same manner as described above. As a result, when the Computer 2 key B12 is operated and the VGA terminal SVa2 is selected, video based on the video signal input to the VGA terminal SVa2 is projected from the video projection unit 10 of the projector 1, and sound based on the sound signal input to the mini jack SAa2 is output from the speaker 2. When the S-Video key B13 is operated and the S terminal SVa3 is selected, video based on the video signal input to the S terminal SVa3 is projected from the video projection unit 10 of the projector 1, and sound based on the sound signal input to the pin jack SAa3 is output from the speaker 2. Similarly, when the Video key B14 is operated and the composite terminal SVa4 is selected, video based on the video signal input to the composite terminal SVa4 is projected from the video projection unit 10 of the projector 1, and sound based on the sound signal input to the pin jack SAa3 is output from the speaker 2.

When the HDMI key B15 is operated, that is, when the HDMI terminal SVa5 is selected, the control unit 31 outputs a control signal indicating the selection of the HDMI terminal SVa5 from the control signal output unit 38 to the projector 1. If the control signal is input through the control signal input unit 13, the control unit 11 of the projector 1 instructs the video signal selection unit 17 to select a video signal separated from an input signal to the HDMI terminal PV5 corresponding to the selected HDMI terminal SVa5, and also instructs the sound signal selection unit 18 to select a sound signal separated from the input signal to the HDMI terminal PV5. The selected sound signal is output from the mini jack PA4 of the sound signal output unit 22, and input to the mini jack SAa4 of the sound signal input unit 34 of the switcher 3 through a cable (not shown). The control unit 31 of the switcher 3 instructs the sound signal selection unit 35 to select a sound signal input to the mini jack SAa4 serving as a sound input terminal corresponding to the HDMI terminal SVa5. As a result, video based on the video signal included in the input signal to the HDMI terminal PV5 of the projector 1, that is, the input signal to the HDMI terminal SVa5 of the switcher is projected from the video projection unit 10 of the projector 1, and sound based on the sound signal included in the input signal, that is, the sound signal input to the mini jack SAa4 is output from the speaker 2.

When the USB key B16 is operated, the switcher 3 and the projector 1 operate in the same manner as described above. In this case, video based on the video signal included in the input signal to the USB terminal PV6 of the projector 1, that is, the input signal to the USB terminal SVa6 of the switcher is projected from the video projection unit 10 of the projector 1, and sound based on the sound signal included in the input signal, that is, the sound signal input to the mini jack SAa4 is output from the speaker 2.

The switcher 3 is configured as described above, and the user can connect one or a plurality of video/sound supply devices 200 to the switcher 3 to supply video signals and sound signals. Each connected input source is selected by the corresponding input source selection key B4 of the switcher 3, such that video based on a video signal can be displayed on the projector 1, and sound based on a sound signal can be output from the speaker 2.

As described above, according to the video/sound reproduction system 100 of this embodiment, the following effects can be obtained.

(1) According to the video/sound reproduction system 100 of this embodiment, the control unit 31 of the switcher 3 performs control such that video based on a video signal input to a video input terminal selected by each input source selection key B4 is displayed on the projector 1, and sound based on a sound signal input to a sound input terminal corresponding to the selected video input terminal is output from the speaker 2. For this reason, when the HDMI terminal SVa5 or the USB terminal SVa6 to which both a video signal and a sound signal are input is selected, the control unit 31 of the switcher 3 performs control such that video based on the video signal input to the HDMI terminal SVa5 or the USB terminal SVa6 is displayed on the projector 1, and sound based on the sound signal input to the mini jack SAa4 corresponding to the HDMI terminal SVa5 or the USB terminal SVa6 is output from the speaker 2. The video signal and the sound signal input to the HDMI terminal SVa5 and the USB terminal SVa6 are input to the HDMI terminal PV5 and the USB terminal PV6 of the projector 1, and are separated into the video signal and the sound signal by the video/sound separation unit 15. The projector 1 projects video based on the separated video signal by the video projection unit 10, and outputs the separated sound signal from the mini jack PA4 of the sound signal output unit 22 to the mini jack SAa4 of the sound signal input unit 34 of the switcher 3. As a result, sound based on the sound signal is output from the speaker 2. That is, there is no need for separating the video signal and the sound signal, which are input to the HDMI terminal SVa5 or the USB terminal SVa6, in the switcher 3 when video display and sound output are performed in different devices, it becomes possible to simplify the configuration of the switcher 3 and to suppress an increase in cost.

(2) According to the video/sound reproduction system 100 of this embodiment, in the switcher 3, a plurality of video input terminals and a plurality of sound input terminals are respectively arranged in two surfaces (first bottom surface 30b1 and second bottom surface 30b2) which are different in height, such that the user easily recognizes connection positions when connecting the cables, thereby improving convenience. Since the terminals which are connected to the projector 1 and the speaker 2 are disposed in the upper surface 30t, even when the cables are constantly connected, there is no damage to the appearance.

In this embodiment, the HDMI terminal SVa5 and the USB terminal SVa6 serving as a video input terminal, to which both a video signal and a sound signal are input, correspond to a first video input terminal.

### Modifications

The foregoing embodiment may be modified as follows.

Although in the foregoing embodiment, the HDMI terminal SVa5 and the USB terminal SVa6 are used as a video input terminal to which both a video signal and a sound signal are input, the invention is not limited thereto. For example, a network terminal to which a video signal and a sound signal are input through a network, such as a LAN (Local Area Network), may be used. Further, as for the input interface, which both a video signal and a sound signal are input through one cable, such as DP (Display Port) can be used.

In the foregoing embodiment, the video signal input unit 14 of the projector 1 and the video signal input unit 32 of the switcher 3 include the Type-B USB terminals PV6 and SVa6, and the video signal output unit 33 of the switcher 3 includes the Type-A USB terminal SVb6. A video signal and a sound signal output from a USB terminal (Type-A terminal) (not shown) of the video/sound supply device 200 (for example, a computer) are input to the projector 1 through the switcher 3. In this case, the video/sound supply device 200 functions as a USB host, and the projector 1 functions as a USB device. Meanwhile, the video signal input unit 14 of the projector 1 and the video signal input unit 32 of the switcher 3 may include Type-A USB terminals, the video signal output unit 33 of the switcher 3 may include a Type-B USB terminal, and a video signal and a sound signal may be input from a USB terminal (Type-B terminal) (not shown) of the video/sound supply device 200 (for example, an imaging device or the like). In this case, the projector 1 functions as a USB host, and the video/sound supply device 200 functions as a USB device.

Although in the foregoing embodiment, the sound signal output unit 37 of the switcher 3 includes the mini jack SAb1, the sound output terminal provided in the sound signal output unit 37 is not limited to the mini jack SAb1. For example, other types of sound output terminals, such as a pin jack, may be provided. The number of sound output terminals provided in the sound signal output unit 37 is not limited to one, and a plurality of sound output terminals may be provided.

Although in the foregoing embodiment, from among the sound input terminals of the sound signal input unit 34 of the switcher 3, the sound input terminal to which the sound signal is input from the sound signal output unit 22 of the projector 1 is the mini jack SAa4, the invention is not limited thereto. Other types of sound input terminals, such as a pin jack, may be used.

Although in the foregoing embodiment, the control signal is output from the switcher 3 to the projector 1 through the RS-232C terminal, the invention is not limited thereto. For example, the control signal may be output through the USB terminal.

Although in the foregoing embodiment, the projector 1 is used as the video display device, the video display device is not limited to the projector 1. For example, other video display devices, such as a rear projector integrally including a transmissive screen, a liquid crystal display, a plasma display, an SED (Surface-conduction Electron-emitter Display), and an organic EL (Electro Luminescence) display, may be used.

What is claimed is:

1. An input selection device comprising:
a plurality of video input terminals to which video signals are input;
a plurality of sound input terminals which are associated with the plurality of video input terminals, and to which sound signals corresponding to the video signals are input;
an input operation unit which receives a selection operation for selecting one of the plurality of video input terminals; and
a control unit which performs control such that video based on a video signal input to a video input terminal selected by the selection operation is displayed on a video display device, and sound based on a sound signal input to a sound input terminal corresponding to the selected video input terminal is output from a sound output device,
wherein the plurality of video input terminals include a first video input terminal to which both a video signal and a sound signal are input, and
the plurality of sound input terminals include a first sound input terminal which is associated with the first video input terminal.

2. The input selection device according to claim 1, further comprising:
a plurality of video output terminals which output the video signals input to the plurality of video input terminals to the video display device; and
a control signal output unit which outputs a control signal to the video display device,
wherein the control unit outputs a control signal according to the selection result of the selection operation from the control signal output unit to perform control such that video based on a video signal input to a video input terminal selected by the selection operation from among the video signals output from the plurality of video output terminals is displayed on the video display device.

3. The input selection device according to claim 1, further comprising:
a sound output terminal which outputs the sound signal to the sound output device; and
a sound signal selection unit which determines a sound signal to be output from the sound output terminal from among the sound signals input to the plurality of sound input terminals in accordance with the selection result of the selection operation.

4. The input selection device according to claim 2, further comprising:
a sound output terminal which outputs the sound signal to the sound output device; and
a sound signal selection unit which determines a sound signal to be output from the sound output terminal from among the sound signals input to the plurality of sound input terminals in accordance with the selection result of the selection operation.

5. The input selection device according to claim 1,
wherein the first video input terminal is an HDMI terminal.

6. The input selection device according to claim 1,
wherein the first video input terminal is a USB terminal.

7. The input selection device according to claim 1,
wherein the first video input terminal is a Display Port terminal.

8. A video/sound reproduction system comprising:
an input selection device to which video signals and sound signals are input;
a video display device which displays video based on a video signal input to the input selection device; and
a sound output device which outputs sound based on a sound signal input to the input selection device,
wherein the input selection device includes
a plurality of video input terminals to which the video signals are input,
a plurality of sound input terminals which are associated with the plurality of video input terminals, and to which the sound signals corresponding to the video signals are input,
an input operation unit which receives a selection operation for selecting one of the plurality of video input terminals, and
a control unit which performs control such that video based on a video signal input to the video input terminal selected by the selection operation is displayed on the video display device, and sound based on a sound signal input to a sound input terminal corresponding to the video input terminal selected by the selection operation is output from the sound output device,
the plurality of video input terminals include a first video input terminal to which both the video signal and the sound signal are input,
the plurality of sound input terminals include a first sound input terminal which is associated with the first video input terminal, and
the video display device includes
a second video input terminal to which the video signal and the sound signal input to the first video input terminal of the input selection device are input from the input selection device,
a separation unit which separates the video signal and the sound signal input to the second video input terminal from each other,
a display unit which, when the first video input terminal is selected by the selection operation, displays video based on the video signal separated by the separation unit, and
a sound output terminal which, when the first video input terminal is selected by the selection operation, outputs the sound signal separated by the separation unit to the first sound input terminal of the input selection device.

9. The video/sound reproduction system according to claim 8,
wherein the input selection device further includes
a plurality of video output terminals which output the video signals input to the plurality of video input terminals to the video display device, and
a control signal output unit which outputs a control signal to the video display device, and
the control unit outputs a control signal according to the selection result of the selection operation from the control signal output unit to perform control such that video based on a video signal input to a video input terminal selected by the selection operation from among the video signals output from the plurality of video output terminals is displayed on the video display device.

10. The video/sound reproduction system according to claim 8,
wherein the input selection device further includes
a sound output terminal which outputs the sound signal to the sound output device, and
a sound signal selection unit which determines a sound signal to be output from the sound output terminal from among the sound signals input to the plurality of sound input terminals on the basis of the selection operation.

11. The video/sound reproduction system according to claim 8,
wherein the first video input terminal is an HDMI terminal.

12. The video/sound reproduction system according to claim 8,
wherein the first video input terminal is a USB terminal.

13. A video/sound reproduction method in a video/sound reproduction system,
wherein the video/sound reproduction system includes
an input selection device to which video signals and sound signals are input,
a video display device which displays video based on a video signal input to the input selection device, and
a sound output device which outputs sound based on a sound signal input to the input selection device,
the video/sound reproduction method comprising:
causing an input selection device to receive a selection operation for selecting a first video input terminal, to which both the video signal and the sound signal are input, from among a plurality of video input terminals;
causing the input selection device to output the video signal and the sound signal input to the first video input terminal to the video display device;
causing the video display device to separate the video signal and the sound signal from each other;
causing the video display device to display video based on the separated video signal;
causing the video display device to output the separated sound signal to the input selection device;
causing the input selection device to output the sound signal input from the video display device to the sound output device; and
causing the sound output device to output sound based on the sound signal input from the input selection device.
